(19) United States
(12) Patent Application Publication
(10) Pub. No.: US 2009/0097136 A1
(43) Pub. Date: Apr. 16, 2009

(54) OPTICAL DEVICE AND IMAGE PICKUP APPARATUS USING THE SAME OPTICAL DEVICE

(75) Inventor: Hironao Otsu, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 12/248,371

(22) Filed: Oct. 9, 2008

(30) Foreign Application Priority Data
Oct. 10, 2007 (JP) 2007264867

(51) Int. Cl. G02B 26/02; G02B 5/20

(52) U.S. Cl. 359/739; 359/888; 348/224.1

(57) ABSTRACT

An optical device including a lens group which generates an optical image on an image pickup area by focusing an image of a photographing object, an optical diaphragm which narrows light flux optically when the optical portion generates the optical image, an ND filter group which is disposed in front of or behind the optical diaphragm and constituted of a plurality of ND filters each having a different light transmittance, and an ND filter adjusting portion which adjusts a positional relation of the ND filter with respect to the optical axis of the optical portion. At least one of the plural ND filters is an oblique ND filter in which the transmittance change line which is a change line of the light transmittance intersects at least two sides constituting the image pickup area obliquely.

### CROSS-REFERENCE TO RELATED APPLICATIONS

This application is based upon and claims the benefit of priority from prior Japanese Patent Application No. 2007-264867, filed Oct. 10, 2007, the entire contents of which are incorporated herein by reference.

### BACKGROUND OF THE INVENTION

1. Field of the Invention

The present invention relates to an optical device having plural kinds of ND filters each having a different light transmittance, and an image pickup apparatus using the same optical device.

2. Description of the Related Art

Technology relating to the image pickup apparatus has been disclosed in, for example, Jpn. Pat. Appln. KOKAI Publication No. 2000-106649. This publication describes an image pickup apparatus having an exposure control mechanism for adjusting the light amount of light flux incident into an image pickup lens system. The exposure control mechanism has an aperture in which an aperture opening is formed when diaphragm-blades are moved in opposite directions to each other on a plane perpendicular to the optical axis and an ND filter portion having at least two kinds of light transmittance. Further, the exposure control mechanism controls the opening area by means of the diaphragm-blades from a fully-open state to a predetermined opening degree when it is displaced in a direction of limiting the light transmission amount from its aperture open state and next, with the predetermined opening maintained, the ND filter is advanced into the aperture opening successively from a filter portion having a high light transmittance.

With the image pickup apparatus and image pickup device progressed in terms of increased sensitivity in recent years, the importance of being able to adjust the light amount of an optical image for taking a picture of a photographing subject is also rising. As a means for adjusting the light amount of an optical image under a certain condition with the exposure time specified as a constant, for example, an optical diaphragm, ND filter and the like are available.

If the means for adjusting the light amount of the optical image is limited to the optical diaphragm, as the light amount is reduced by means of this optical diaphragm, small-aperture blurring originating from the light diffraction phenomenon occurs in the optical image. For this reason, there is available a means for inserting an ND filter for the optical diaphragm so that the optical diaphragm is not over-narrowed on an aperture plane.

However, when the ND filter is inserted momentarily into the entire aperture plane during recording a picked up image, this momentary status when the ND filter is inserted is photographed and recorded.

As an answer to this problem, the method mentioned in Jpn. Pat. Appln. KOKAI Publication No. 2000-106649 is available. That is, with the optical diaphragm maintained in a predetermined opening (aperture plane) condition, the ND filter is advanced (inserted) into the aperture opening (aperture plane) gradually in succession from the filter portion having the high light transmittance. Consequently, the small-aperture blurring by the optical diaphragm is reduced, and further, the momentary status when the ND filter is inserted is made inconspicuous.

### BRIEF SUMMARY OF THE INVENTION

Accordingly, an object of the present invention is to provide an optical device having an optical design and optical control in which the small-aperture blurring of the optical image due to the optical diaphragm is reduced when the light amount of the optical image is adjusted; in which the state of a moment when the ND filter is inserted is made inconspicuous when the ND filter is inserted into the aperture plane on photographing and recording; in which the MTF (modulation transfer function) in the horizontal direction of the optical image and the MTF in the vertical direction approximately coincide with each other when the transmittance change line of the ND filter exists within the aperture plane of the ND filter or the deterioration ratio of at least the MTF deterioration in the horizontal direction and the MTF deterioration in the vertical direction is kept approximately constant; and in which changes of the MTF deterioration due to the small-aperture blurring of the optical image is reduced even when the transmittance change line of the ND filter moves with respect to the aperture plane while changing.

Therefore, an object of the present invention is to provide an optical device, comprising: an optical portion which generates an optical image on an image pickup area by focusing an image of a photographing object; an optical diaphragm which narrows light flux optically when the optical portion generates the optical image; an ND filter group which is disposed in front of or in the back of the optical diaphragm and constituted of a plurality of ND filters each having a different light transmittance; and an ND filter adjusting portion which adjusts a positional relation of said each ND filter with respect to the optical axis of the optical portion, wherein at least one of said plurality of ND filters is an oblique ND filter in which the transmittance change line which is a change line of the light transmittance intersects at least two sides constituting the image pickup area obliquely.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of an optical device according to a first embodiment of the present invention;

FIG. 2A is a diagram showing an example of the filter shape of an oblique ND filter shown in FIG. 1, and FIG. 2B is a diagram showing an example of a geometric relationship between the filter shape of the oblique ND filter shown in FIG. 1 and an image pickup area;

FIG. 3 is a diagram showing an example of a two-blade optical diaphragm;

FIGS. 4A to 4D are diagrams showing an example of the aperture planes formed by the positional relationship between the diaphragm blade (upper) and the diaphragm blade (lower) of the two-blade optical diaphragm shown in FIG. 3;

FIGS. 5A to 5D are diagrams showing an example of the positional relationship between the ND filter group shown in FIG. 2A and diaphragm borderlines shown in FIGS. 4A to 4D;

FIGS. 6A to 6D are diagrams showing an example of adjustment of the light transmittance based on the positional relation between the ND filter group shown in FIG. 2A and the diaphragm borderline (aperture plane) shown in FIG. 5C;

FIGS. 7A and 7B are diagrams showing changes of the length of the transmittance change line within the aperture plane of an ordinary ND filter group;

FIGS. 8A and 8B are diagrams showing that the length of the transmittance change line within the aperture plane of the ND filter group according to the first embodiment of the present invention is kept approximately constant;

FIGS. 9A to 9D are diagrams showing an example of the positional relationship between the transmittance change line of the oblique ND filter according to the first embodiment of the present invention and the diaphragm borderline (aperture plane);

FIGS. 10A and 10B are diagrams showing an example of a case where one of the diagonal lines of the oblique ND filter is not approximately parallel to the horizontal direction of an image pickup area shown in FIG. 2B;

FIGS. 11A and 11B are diagrams showing an example of a case where the transmittance change line of the oblique ND filter is not approximately parallel to two sides of four sides of the diaphragm borderline;

FIG. 12 is a block diagram showing the configuration of an image pickup device using the optical device of the first embodiment, according to a second embodiment of the present invention;

FIG. 13 is a diagram showing an example of the hysteresis width to be set by the ND filter control portion;

FIG. 14 is a diagram showing a passage of a position adjustment amount of the ND filter group which is controlled based on the hysteresis width shown in FIG. 13;

FIG. 15 is a diagram showing an example of a hunting width generated under the ND filter position adjustment amount (control amount);

FIG. 16 is an appearance diagram showing an example of the ND filter operation portion and the control/operation priority mode selecting portion, disposed on an image pickup device casing surface, according to the second embodiment of the present invention; and

FIG. 17 is an appearance diagram showing an example of the ND filter operation portion and the control/operation priority mode selecting portion, disposed on the image pickup device casing surface, according to the second embodiment of the present invention.

### DETAILED DESCRIPTION OF THE INVENTION

Hereinafter, the embodiments of the present invention will be described with reference to the accompanying drawings.

### First Embodiment

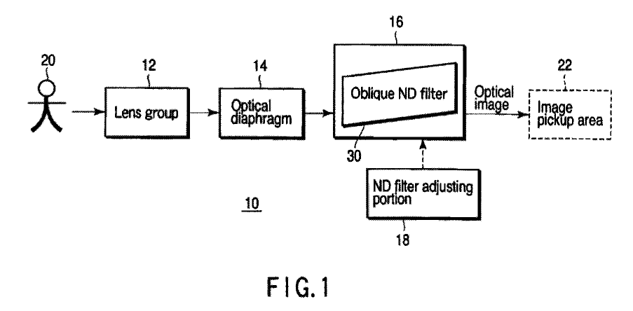

FIG. 1 is a block diagram showing the configuration of the optical device according to the first embodiment of the present invention.

Referring to FIG. 1, this optical device 10 includes a lens group (optical portion) 12, an optical diaphragm 14, an ND filter group 16, and an ND filter-adjusting portion 18.

The lens group 12 generates an optical image on an image pickup plane 22 by focusing the image of a photographing object 20 at an arbitrary position of the optical axis. The optical diaphragm 14 narrows the light flux optically when generating the optical image.

The ND filter group 16 is disposed in front of or behind the optical diaphragm 14 and constituted of plural ND filters each having a different light transmittance. The ND filter-adjusting portion 18 adjusts a positional relation of the respective ND filters with respect to the optical axis of the lens group 12. At least one of the plural ND filters is an oblique ND filter 30 in which the transmittance change line, which is a change line of the light transmittance, intersects at least two sides constituting the image pickup area 22.

As shown in FIG. 1, the photographing object 20 and the image pickup area 22 are set in a virtual constitution on an assumption that the optical device 10 of the first embodiment of the present invention is actually used. Further, the image pickup area 22 may be a face, based on the assumption of an arrangement face of, for example, an image sensor such as CCD and MOS type image pickup device or a photosensitive film. The optical device 10 of the first embodiment of the present invention may be, for example, a microscope, an opera glass or a telescope in which the image pickup area is a naked eye.

The optical device of the first embodiment of the present invention may be provided with an image sensor and the details of a case where the image sensor is provided will be given in the second embodiment.

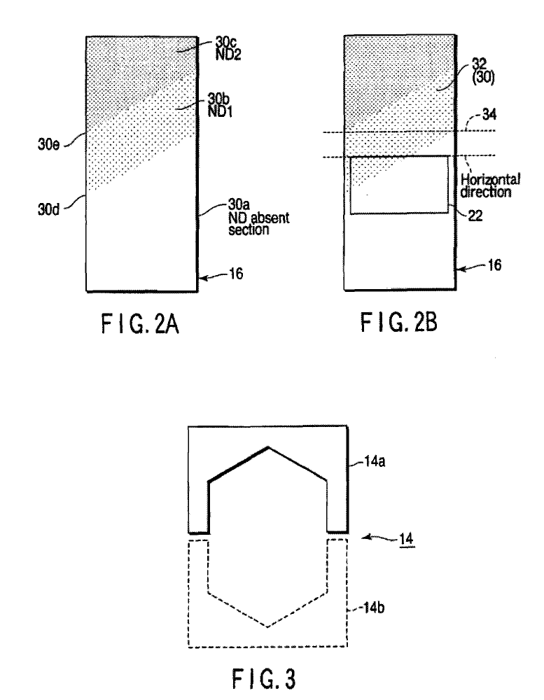

FIG. 2A is a diagram showing an example of the filter shape of the oblique ND filter shown in FIG. 1 and FIG. 2B is a diagram showing an example of the geometric relationship between the filter shape of the oblique ND filter shown in FIG. 1 and the image pickup area.

In FIG. 2A, this ND filter group 16 is constituted of plural ND filters each having a different light transmittance. That is, this ND filter group 16 is constituted of, for example, an ND absent section (light transmittance 1) 30a having a light transmittance of 1, an ND1 section 30b having a light transmittance of ¼ and an ND2 section 30c having a light transmittance of 1/16.

A joint between the ND1 section 30b and the ND absent section 30a and a joint between the ND2 section 30c and the ND1 section 30b are the light transmission change lines 30d, 30e. These two light transmission change lines 30d, 30e have rhombicity. The ND1 section 30b is an oblique ND filter. The rhombicity mentioned here refers to a state in which the light transmission change line intersects at least two sides constituting the image pickup area obliquely.

FIG. 2B shows an example of the geometric relationship between the filter shape of the oblique ND filter 30 and the image pickup area 22 by representing the ND filter group 16 and the image pickup area 22 such that they overlap each other. In FIG. 2B, the filter shape of this oblique ND filter 30 (ND1 section 30b) is a parallelogram and a diagonal line 34 of this parallelogram is approximately parallel to the horizontal direction of the image pickup area 22.

In the meantime, this ND filter group 16 is not limited to the ND2 section, ND1 section and ND absent section having three kinds of light transmittances, and may include the ND3 section and ND4 section. For example, if a photographing scene in fine weather in the daytime is assumed, the optical filter may be constituted of a combination of the ND filter and a color temperature conversion filter. Further, plural different light transmittances may be combined in various ways and may be applied in various ways.

FIG. 3 is a diagram showing an example of the two-blade diaphragm.

Referring to FIG. 3, this optical diaphragm 12 is constituted of two blades: a diaphragm blade (upper) (indicated with solid line) 14a and a diaphragm blade (lower) (indicated with dotted line) 14b.

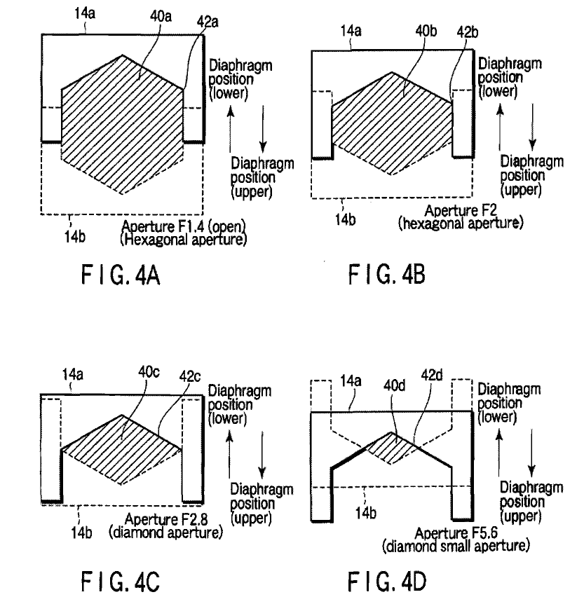

FIGS. 4A to 4D are diagrams showing an example of the aperture planes formed by the positional relationship between the diaphragm blade (upper) 14a and the diaphragm blade (lower) 14b of the two-blade optical diaphragm shown in FIG. 3.

FIG. 4A shows the optical diaphragm having a regular hexagonal aperture plane (indicated with oblique lines) 40a, which is a result of adjusting the diaphragm position of the diaphragm blade (upper) (indicated with solid line) 14a and a diaphragm blade (lower) (indicated with dotted line 14b). A borderline between the diaphragm blades 14a, 14b and the aperture plane 40a serves as a borderline 42a.

FIG. 4B shows an optical diaphragm in which the area of the aperture plane 40b is about ½ the area of the aperture plane 40a shown in FIG. 4A as a result of adjusting the diaphragm position between the diaphragm blade (upper) 14a and the diaphragm blade (lower) 14b by slightly closing further from the diaphragm position shown in FIG. 4A. An aperture plane 40b shown in FIG. 4B is of a slightly distorted hexagonal shape.

FIG. 4C shows an optical diaphragm in which the area of the aperture plane 40c is about ¼ the area of the diaphragm 40a shown in FIG. 4A as a result of adjusting the diaphragm positions of the diaphragm blade (upper) 14a and the diaphragm blade (lower) 14b by slightly closing further from the diaphragm position shown in FIG. 4B. The aperture plane 40c shown in FIG. 4C is diamond-shaped.

FIG. 4D shows an optical diaphragm in which the area of the aperture plane 40d is about 1/16 the area of the aperture plane 40a shown in FIG. 4A as a result of adjusting the diaphragm positions of the diaphragm blade (upper) 14a by closing further from the diaphragm position shown in FIG. 4C. The diaphragm plane 40d shown in FIG. 4D is a diamond smaller than that shown in FIG. 4C.

FIGS. 4A to 4D are diagrams showing that the F number (aperture value) of the optical diaphragm 14 can be adjusted continuously by adjusting the positional relationship of the two diaphragm blades of the diaphragm blade (upper) 14a and the diaphragm (lower) 14b.

The polygonal aperture planes 40a to 40d shown in FIGS. 4A to 4D need not be strictly polygonal. For example, the aperture planes may have a shape having rounded corners or having curved sides and may be applied in various ways.

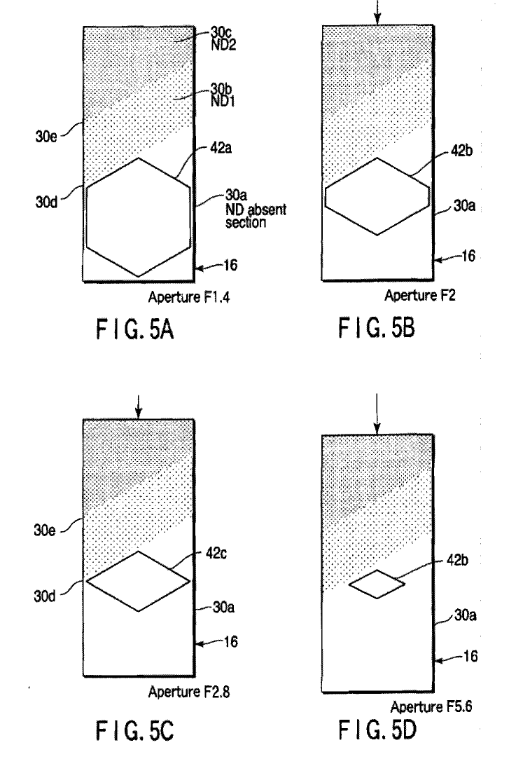

FIGS. 5A to 5D are diagrams showing an example of the positional relationship between the ND filter group 16 shown in FIG. 2A and diaphragm borderlines 42a to 42d shown in FIGS. 4A to 4D.

FIG. 5A is a diagram showing a state in which the diaphragm borderline 42a of the aperture F1.4 (fully open), composed of a hexagonal shape shown in FIG. 4A, is indicated such that it overlaps a the ND-absent area 30a of the ND filter group 16 shown in FIG. 2A.

FIG. 5B is a diagram showing a state in which the diaphragm borderline 42b of the aperture F2 composed of hexagonal shape shown in FIG. 4B is indicated such that it overlaps the ND-absent area 30a of the ND filter group 16 shown in FIG. 2A. In this figure, the positional of the ND filter group 16 is adjusted corresponding to changes in the shape of the F2 diaphragm borderline 42b shown in FIG. 5B from the shape of the F1.4 (fully open) diaphragm borderline 42a shown in FIG. 5A, so as to adjust the positional relation of the ND filter group 16 with respect to the diaphragm borderline.

FIG. 5C is a diagram showing the F2.8 diaphragm borderline 42c composed of a diamond shown in FIG. 4C such that it overlaps the ND-absent area 30a of the ND filter group 16 shown in FIG. 2A. In this way, even if the diaphragm shape is a diamond, the relation of the ND filter group 16 is adjusted corresponding to changes of the shape of the diaphragm borderline so as to adjust the positional relationship with respect to the diaphragm borderline of the ND filter group 16.

FIG. 5D is a diagram showing a state in which the diaphragm borderline 42d having an aperture F5.6 composed of a small diamond shown in FIG. 4D is indicated such that it overlaps a place of the ND absent section 30a of the ND filter group 16 shown in FIG. 2A. If the diaphragm by the small diamond aperture plane shown in FIG. 5D is F5.6, there is a fear that the optical image may be deteriorated in terms of MTF due to the small-aperture blurring.

As the optical diaphragm 14 is narrowed from the aperture F1.4 (fully opened) shown in FIG. 5A to the aperture F2 shown in FIG. 5B, the aperture F2.8 shown in FIG. 5C to the aperture F5.6 shown in FIG. 5D, the position of the ND filter group 16 is fed downward gradually based on the positional relation with respect to the diaphragm borderline. The reason for this is that the moving distance of the diaphragm needs to be reduced in order to move the diaphragm from the ND absent section 30a to the ND1 30b rapidly.

As shown in FIGS. 5A to 5D, a predetermined margin (distance) may be provided between the diaphragm borderline 42a to 42d and the light transmittance change line 30d.

If the aperture is F5.6 as shown in FIG. 5D, the degree of the deterioration of the optical image in terms of MTF due to the small-aperture blurring is larger than in a case where the diaphragm made by a circular aperture plane is F5.6. Thus, unless a photographing request of, for example, increasing the depth of field, is provided, it is recommended to stop the narrowing of the diaphragm around F2.8 shown in FIG. 5C and adjust the light amount with the ND filter, so as to prevent the small-aperture blurring of the optical image due to the optical diaphragm.

If the photographing request of, for example, increasing the depth of the field is provided, it is recommended to use the optical device capable of taking a picture with an aperture of F5.6 as shown in FIG. 5D. Photographing may be permitted around the aperture F4 (not shown) which is an aperture at a middle position between FIGS. 5C and 5D.

As described above, if the adjustment of the light amount is carried out using the ND filter rather than by narrowing the optical diaphragm 14, the small-aperture blurring due to the optical diaphragm is reduced, so as to reduce the MTF deterioration of the optical image. However, if in photographing with a movie camera, an ordinary ND filter composed of a single sheet is inserted at one stroke during photographing and recording, a state of a moment when this ND filter is inserted is conspicuous.

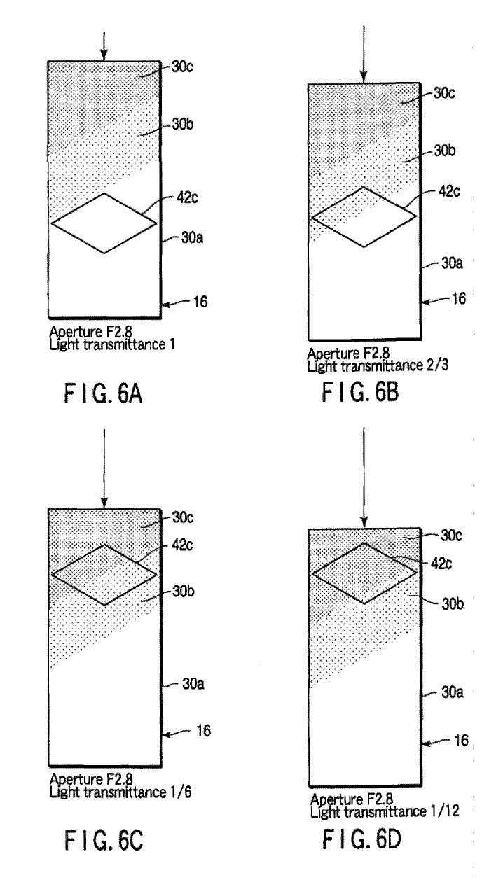

The optical method which makes the state of a moment when this ND filter is inserted inconspicuous even when the ND filter is inserted into the aperture plane on photographing and recording will be described with reference to FIGS. 6A to 6D.

FIGS. 6A to 6D are diagrams showing an example of adjustment of the light transmittance based on the positional relation between the ND filter group 16 shown in FIG. 2A and the diaphragm borderline (aperture plane) 42c shown in FIG. 5C.

FIGS. 6A to 6D do not show a discontinuous frame operation (instantaneous movement) but a smooth and continuous operation obtained in a predetermined operating time.

FIG. 6A is a diagram showing a state of the ND absent (light transmittance 1) 30a under an aperture F2.8.

In this optical diaphragm, with the aperture F2.8 shown in FIG. 6A maintained, the positional relation with respect to the aperture plane of the ND filter group 16 is lowered continuously, gradually. Then, as shown in FIG. 6B, an aperture plane in which the ND1 section (oblique ND filter) 30b having a light transmittance of ¼ and the ND absent section 30a having a light transmittance of 1 coexist is obtained.

In FIG. 6B, the positional relation of the ND filter group with respect to the aperture plane is adjusted so that the entire aperture plane has a light transmittance of ⅔.

FIG. 6C shows a state in which the positional relation of the ND filter group 16 with respect to the aperture plane is lowered further relative to a positional relation shown in FIG. 6B with the aperture F2.8 maintained. In the aperture plane of FIG. 6C, the ND2 section 30c and the ND1 section 30b are mixed, which is equivalent to generation of an ND filter having a light transmittance of ⅙ based on its mixing ratio.

FIG. 6D is equivalent to generation of an ND filter having a light transmittance of 1/12 based on the mixing ratio between the ND2 section 30c and the ND1 section 30b.

By adjusting the positional relation of the ND filter group 16 with respect to the aperture plane continuously, two light transmittances of three different sections; the ND absent section 30a, ND1 section 30b, and ND2 section 30c are made to coexist at the same time, thereby enabling smooth and continuous fine adjustment of the light amount.

By the smooth and continuous fine adjustment of the light amount, an effect of making the state of a moment when the ND filter is inserted inconspicuous is obtained even when the ND filter is inserted into the aperture plane on photographing and recording.

The aforementioned optical diaphragm 14 is not limited to maintaining the aperture F2.8 and the same effect can be obtained if the same adjustment is implemented with the aperture F4, aperture F5.6 or other F number.

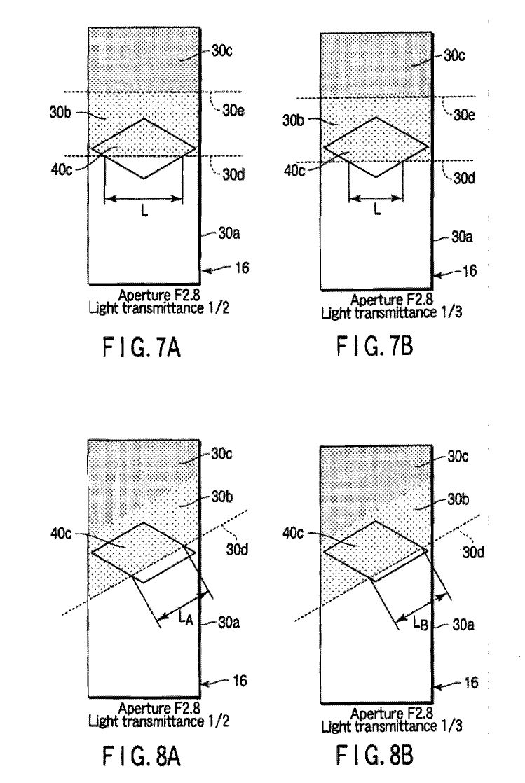

Next, the relation between the state (length and angle with respect to the image pickup area) of the light transmittance change line within the aperture plane and the deterioration of the horizontal/vertical MTF of the optical image will be described with reference to FIGS. 7A, 7B and FIGS. 8A, 8B.

FIGS. 7A and 7B are diagrams showing changes of the length of the light transmittance change lines within the aperture plane by the ordinary ND filter group. A range indicated by L in the same Figure represents the length of the light transmittance change line within the aperture plane.

The ordinary ND filter group 16 shown in FIGS. 7A, 7B has the light transmittance change lines 30d, 30e arranged in the horizontal direction and contains, for example, the ND absent section (light transmittance) 30a, ND1 section (light transmittance ¼) 30b and ND2 section (light transmittance 1/16) 30c.

FIGS. 7A and 7B show the diaphragm borderline (aperture plane) which overlaps the ND filter group 16, and as shown in FIGS. 4A to 4D, the aperture plane is formed from the positional relation between the diaphragm blade (upper) 14a and the diaphragm (lower) 14b composed of two blades and this indicates the state of the aperture F2.8 shown in FIG. 4C.

In the diaphragm 40c shown in FIGS. 7A and 7B, the ND1 section 30b and the ND absent section 30a are mixed, and from the viewpoint of the mixing ratio, FIG. 7A is equivalent to generation of an ND filter having a light transmittance of ½ and FIG. 7B is equivalent to generation of an ND filter having a light transmittance of ⅓.

Here, the light transmittance change line 30d within the aperture plane 40c shown in FIGS. 7A and 7B is paid attention to. As a result, it is found that the light transmittance change line 30d within the aperture plane 40c shown in FIG. 7A is longer than the light transmittance change line 30d within the aperture plane 40c shown in FIG. 7B.

In the optical device shown in FIGS. 7A and 7B, it is found that in a process of adjusting the light transmittance of the ND filter by adjusting the positional relation of the ND filter group 16, the length L of the transmittance change line within the aperture plane is changed. Due to the changes of the length L of the transmittance change line within the aperture plane, the degree of the deterioration of the optical image in terms of horizontal/vertical MTF is changed. Thus, in the case of FIGS. 7A and 7B, the vertical MTF is deteriorated in FIG. 7A more than in FIG. 7B.

In the optical device shown in FIGS. 7A and 7B, the transmittance change line within the aperture plane is in a horizontal direction. Thus, the light diffraction phenomenon in which an optical image originating from the transmittance change line within the aperture plane is generated only in the vertical direction of the optical image but not in the horizontal direction of the optical image is brought about.

That is, the optical image produced by the optical device shown in FIGS. 7A and 7B has an unnatural image characteristic (astigmatic phenomenon of the optical image) in which the horizontal MTF and vertical MTF do not agree with each other. Further, there is a disadvantage that the MTF in the vertical direction is changed with the adjustment of the light transmittance.

FIGS. 8A and 8B are diagrams indicating that the length of the transmittance change line within the aperture plane by the ND filter group of the first embodiment of the present invention is maintained approximately constant. In the meantime, ranges indicated by L_{A}, L_{B} in FIGS. 8A, 8B indicate the length of the transmittance change line within the aperture plane.

The ND filter group 16 shown in FIGS. 8A and 8B has the oblique ND filter 30 and the same constitution and principle as those shown in FIGS. 6A to 6D. The transmittance change line 30d is provided obliquely and the ND absent section (light transmittance 1) 30a, the ND1 section (light transmittance ¼) 30b and the ND2 section (light transmittance 1/16) 30c are provided.

FIGS. 8A and 8B show the diaphragm borderline (aperture plane) which overlaps the ND filter group 16, indicating a state having the aperture F2.8 shown in FIG. 4C. In the aperture plane in FIGS. 8A and 8B, the ND1 section 30b and the ND absent section 30a are mixed, and from viewpoint of the mixing ratio, FIG. 8A is equivalent to generating an ND filter having a light transmittance of ½ and FIG. 8B is equivalent to generating an ND filter having a light transmittance of ⅓.

Here, the transmittance change line 30d within the aperture plane 40c shown in FIGS. 8A and 8B is paid attention to. Thus, the length L_{A} of the transmittance change line 30d within the aperture plane 40c shown in FIG. 8A is approximately equal to the length L_{B} of the transmittance change line 30d within the aperture plane 40c.

In the optical device shown in FIGS. 8A and 8B, it is found that in a process of adjusting the light transmittance of the ND filter by adjusting the positional relation of the ND filter group, the length L of the transmittance change line within the aperture plane is changed. For these reasons, the change of the MTF deterioration due to the small-aperture blurring of the optical image is reduced in the optical device shown in FIGS. 8A and 8B.

This transmittance change line within the aperture plane is oblique. Thus, light diffraction phenomenon of the optical image originating from the transmission line change line within the aperture plane is generated both in the vertical direction and the horizontal direction of the optical image, so as to obtain an optical image in which the MTF deterioration in the horizontal direction and the MTF deterioration in the vertical direction approximately coincide with each other.

As described above, the optical device shown in FIG. 7A and the optical device shown in FIG. 8A have the same aperture of F2.8 and light transmittance of ½, and the optical device shown in FIG. 7B and the optical device shown in FIG. 8B have the same aperture of F2.8 and light transmittance of ⅓. However, the optical devices having the oblique ND filter shown in FIGS. 8A, 8B can obtain an ideal optical image.

Next, an example of adjusting the positional relation of the ND filter group (each ND filter) by skip-control so as to prevent the transmittance change line and the diaphragm borderline from being static in an approximately coincident state will be described below.

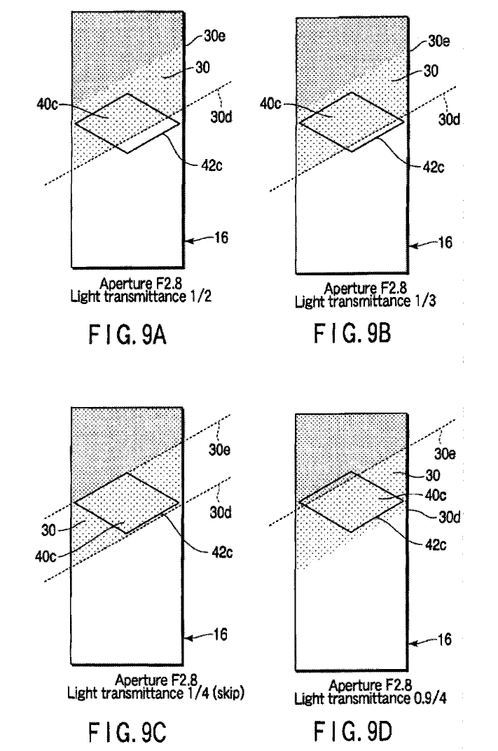

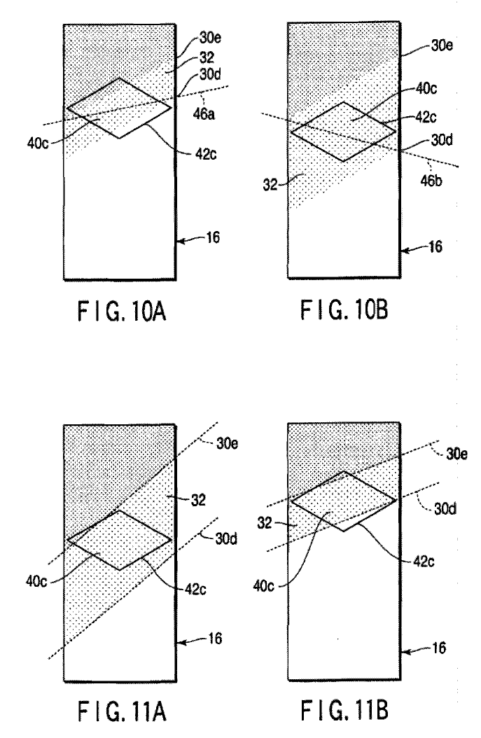

FIGS. 9A to 9D are diagrams showing an example of the positional relation between the transmittance change line by the oblique ND filter of the first embodiment of the present invention and the diaphragm borderline (aperture plane).

FIG. 9A shows the ND filter group and the diaphragm borderline (aperture plane) of the optical diaphragm such that they overlap each other. FIG. 9A has an aperture of F2.8 and light transmittance of ½. The state of FIG. 9B shows a state in which the diaphragm is adjusted to a light transmittance of ⅓ from the state of FIG. 9A with F2.8 maintained.

In the states of FIGS. 9A and 9B, the transmittance change line 30d possessed by the oblique ND filter 30 including the ND filter group is not approximately coincident to the diaphragm borderline 42c.

FIG. 9C shows a state in which, as a result of adjusting the positional relation of the ND filter group with respect to the aperture plane from the state of FIG. 9B, the light transmittance is adjusted to ¼ with the aperture of F2.8 maintained. It should be noted here that the transmittance change lines 30d and/or 30e possessed by the oblique ND filter 30 described previously approximately coincide with the diaphragm borderline 42c, so that the aperture plane 40c has no transmittance change line.

No change of the length of the transmittance change line within the aperture plane in a process of adjusting the light transmittance of the ND filter by adjusting the positional relation of the ND filter with respect to the aperture plane is a reason for reduction of changes of the MTF deterioration due to the small-aperture blurring of the optical image. Therefore, when the aperture plane 40c has no transmittance change line, as in FIG. 9C, the degree of the MTF deterioration is reduced while the change of the MTF deterioration is increased.

Therefore, in the positional relation of the ND filter in which the transmittance change line 30d and/or 30e approximately coincides with the diaphragm borderline 42c as shown in FIG. 9C, the positional relation of the ND filter group (each ND filter) needs to be adjusted by making a control (skip control) to pass this state of FIG. 9C quickly to prevent the diaphragm from being stopped in the state of FIG. 9C.

This skip control adjusts the position of the ND filter group 16 with respect to the aperture plane 40c to change from the positional relation of the ND filter group 16 shown in FIG. 9A to be in the positional relationship of the ND filter group 16 shown in FIG. 9B. Thus, the diaphragm is moved to be in the positional relationship of the ND filter group 16 shown in FIG. 9D by skipping the positional relation of the ND filter group 16 shown in FIG. 9C, that is, passing that state quickly.

While the optical condition of FIG. 9C is an aperture of F2.8 and light transmittance of ¼, the optical condition of FIG. 9D is an aperture of F2.8 and light transmittance of 0.9/4, thus the light transmittance is reduced by about 10%.

Although the light transmittance is reduced by skip control of the positional relation of the ND filter group, the change of the MTF deterioration due to the small-aperture blurring of the optical image can be reduced.

As the skip control, a mechanical (mechanically driven type) and/or electric motor control type (electric signal control type) are available. If this optical device is used for photographing of still images, a device for preventing release of the still image during the skip control may be used. Further, if this optical device is used for taking a movie or consecutive photographing of still pictures, a design for executing the skip control in a blanking period of a photographing synchronous signal may be made.

Next, the shape of the oblique ND filter which is easier to control and can exert a higher performance in order to adjust the positional relationship of the ND filter with respect to the aperture plane will be described.

FIGS. 10A and 10B are diagrams showing an example of a case where one of the diagonal lines of the oblique ND filter is not approximately parallel to the horizontal direction of the image pickup area shown in FIG. 2B.

Note that one of the diagonal lines (not shown) of the oblique ND filter (parallelogram) 30 shown in FIGS. 9A to 9D is approximately parallel to the horizontal direction of the image pickup area (not shown), like the filter shape 32 of the oblique ND filter 30 shown in FIG. 2B. If attention is paid to a diagonal line 46a of the oblique ND filter shown in FIG. 10A, it is evident that it is not parallel to the horizontal direction of the image pickup area (not shown).

A difference between a case where one of the diagonal lines of the oblique ND filter (parallelogram) 30 (32) is approximately parallel to the horizontal direction of the image pickup area (for example, FIGS. 9A to 9D) and a case where it is not approximately parallel (for example, FIGS. 10A and 10B) will be described. In FIGS. 9A to 9D, a transmittance change line of the oblique ND filter 30 always having the same length exists within the aperture plane 40c shown in FIGS. 9A, 9B, 9D except FIG. 9C to be skip-controlled. Contrary to this, two transmittance change lines of the oblique ND filter 30 exist within the aperture plane 40c shown in FIG. 10A.

For example, if two transmittance change lines (30d, 30e) of the oblique ND filter 30 exist within the aperture plane 40c as shown in FIG. 10A, the degree of deterioration of the MTF is higher than a case where a transmittance change line is present. That is, to reduce changes of the MTF deterioration due to the small-aperture blurring of the optical image, a diagonal line of the oblique ND filter (parallelogram) 30 (32) is desired to be approximately parallel to the horizontal direction of the image pickup area, as indicated with reference numeral 34 of FIG. 2B.

If attention is paid to a diagonal line of the oblique ND filter shown in FIG. 10B, it is not approximately parallel to the horizontal direction of the image pickup area (not shown). The transmittance change lines 30d, 30e of the oblique ND filter 32 do not exist within the aperture plane 40c shown in FIG. 10B. Thus, this state should be skip-controlled for the same reason as described in FIG. 9C. In this case also, to reduce the changes of the MTF deterioration due to the small-aperture blurring of the optical image, one of the diagonal lines of the oblique ND filters (parallelogram) 32 is desired to be approximately parallel to the horizontal direction of the image pickup area, as indicated with reference numeral 34 of FIG. 2B.

FIGS. 11A and 11B are diagrams showing an example that the transmittance change lines of the oblique ND filter are not approximately parallel to two sides of four sides of the diaphragm borderlines.

First, pay attention to the transmittance change lines of the oblique ND filter (parallelogram) shown in FIGS. 9A to 9D. It is evident that the transmittance change lines 30d, 30e are approximately parallel to two sides of the four sides of the diaphragm borderlines 42c shown in FIGS. 9A to 9D.

Next, pay attention to the transmittance change lines of the oblique ND filter shown in FIGS. 11A and 11B. It can be seen that the transmittance change lines 30d, 30e are not approximately parallel to two sides of the four sides of the diaphragm borderlines 42c shown in FIGS. 11A and 11B.

A difference between a case where the transmittance change lines 30d, 30e of the oblique ND filters (parallelogram) 30 (32) are approximately parallel to two sides of the four sides of the diaphragm borderlines 42c (for example, FIGS. 9A to 9D) and a case where the lines are not approximately parallel (for example, FIGS. 11A and 11B) will be described. The transmittance change line of only about 0.5 pieces exists within the aperture plane 40c shown in FIG. 11A and for example, the transmittance change line of about 1.5 pieces exists within the aperture plane shown in FIG. 11B. Then, if the lengths of the transmittance change lines within the aperture plane 40c are different, the degrees of the MTF deterioration are different.

From the above description, to obtain an effect of reducing changes of the MTF deterioration due to the small-aperture blurring of the optical image if the transmittance change lines of the ND filter move with respect to the aperture plane while changing, the following event occurs. That is, one of the ideal conditions is that the filter shape of the oblique ND filter is a parallelogram, one of the diagonal directions of this parallelogram is approximately parallel to the horizontal direction of the image pickup area or the vertical direction of the image pickup area and the transmittance change line is approximately parallel to the two sides of the aperture plane.

As described above, the first embodiment can provide an optical device provided with an optical design and optical control for reducing the small-aperture blurring of the optical image due to the optical diaphragm when the light amount of the optical image is adjusted.

Further, the first embodiment can provide an optical device provided with an optical design and optical control for making the state of a moment when this ND filter is inserted inconspicuous when the ND filter is inserted into the aperture plane on photographing and recording.

Still further, the first embodiment can provide an optical device provided with an optical design and optical control in which the MTF in the horizontal direction of the optical image and the MTF in the vertical direction approximately coincide with each other when the transmittance change line of the ND filter exists within the aperture plane or the deterioration ratio of at least the MTF deterioration in the horizontal direction and the MTF deterioration in the vertical direction is kept approximately constant.

Still further, the first embodiment can provide an optical device provided with an optical design and optical control for reducing changes of the MTF deterioration due to the small-aperture blurring of the optical image when the transmittance change line of the ND filter moves with respect to the aperture plane while changing.

The shape of the ND filter group shown in the first embodiment can be applied in various ways and may be of rectangular plate, rectangular tape or of U-shaped rounded laminated configuration.

### Second Embodiment

Next, the second embodiment of the present invention will be described.

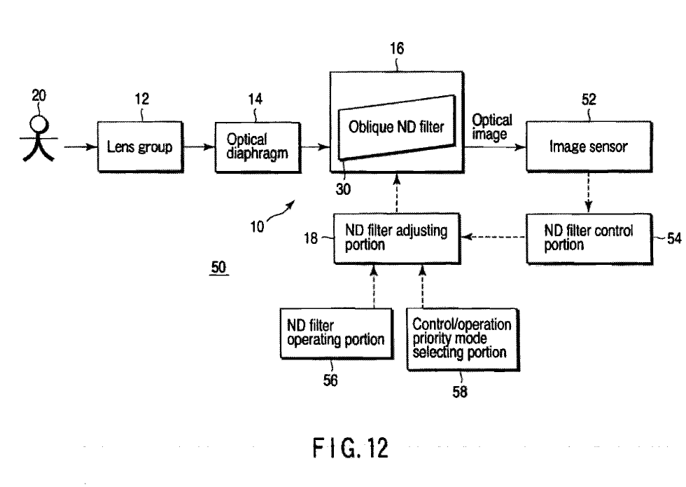

FIG. 12 is a block diagram showing the configuration of the image pickup device using the optical device shown in the first embodiment, according to the second embodiment of the present invention.

The basic configuration and operation of the optical device according to the second embodiment described below are the same as the first embodiment. Therefore, to avoid any duplicated description, like reference numerals are attached to like components and only different portions will be described by omitting a representation and detailed description of the like components.

In FIG. 12, this image pickup device 50 is an image pickup device using the optical device of the first embodiment shown in FIG. 1. That is, the image pickup device 50 includes the optical device 10 constituted of the lens group 12, the optical diaphragm 14, the ND filter group 16 and the ND filter adjusting portion 18, and an image sensor (image pickup portion) 52, an ND filter control portion (ND filter control portion) 54, an ND filter operation portion (ND filter operation portion) 56 and a control/operation priority mode selecting portion (control/operation priority selecting portion) 58. FIG. 12 is a block diagram showing the configuration concerning automatic control of the ND filter group (or each ND filter) and/or manual operation of the ND filter group.

The image sensor 52 is disposed on the above-described image pickup area 22 (see FIG. 1) for converting an optical image photoelectrically so as to generate an image pickup signal. The ND filter control portion 54 controls the ND filter-adjusting portion 18 based on an integration value of the image pickup signal. If the polygonal aperture plane of the optical diaphragm composed of two blades forms a square (diamond) aperture plane as shown in FIGS. 4C, 4D, the following event occurs.

That is, as shown in FIGS. 9A to 9D, the ND filter control portion 54 controls the ND filter adjusting portion 18 so that the transmittance change line exists within this square aperture plane. In the state of FIG. 9C, a higher quality optical image can be obtained by executing the skip-control.

In the meantime, the skip control of this case may be a control by the ND filter-adjusting portion 18 and/or a control by the ND filter control portion 54.

If the polygonal aperture plane forms a hexagonal aperture plane as shown in FIGS. 4A and 4B, the ND filter control portion 54 may control the ND filter adjusting portion 18 so that no transmittance change line exists within this hexagonal aperture plane as shown in FIGS. 5A and 5B.

The ND filter control portion 54 may automatically control the adjustment of light transmittance of the ND filter group 16. If the light transmittance is automatically controlled, this ND filter control portion 54 may control a wobbling width including a position in which the transmittance change line and the diaphragm borderline approximately coincide with each other, based on a hysteresis width, which is larger than the wobbling width, so that the position of the ND filter group 16 is not wobbled. As the factor for generating this wobbling operation, a deflection of the integration value of an image pickup signal originating from changes of image pickup condition, a control error upon controlling the ND filter and the like can be mentioned.

This hysteresis control refers to a control for holding the hysteresis in the state of FIG. 9D (holding in a standby state by not allowing a sequence mentioned below to be performed), in the sequence in which the position of the ND filter group 16 is adjusted to the state of FIG. 9B from the state of FIG. 9D by skipping the state of FIG. 9C by automatic control of the light transmittance.

After, for example, a case where the state of FIG. 9A is demanded is reached, it is favorable to make a control for escaping from this hysteresis and then moving to the state of FIG. 9A. Although the wobbling action between FIGS. 9A and 9B can be executed by implementing such hysteresis control, there is an effect of preventing the wobbling action by FIGS. 9D and 9B which sandwich the state of FIG. 9C. That is, there is an effect of reducing the frequency of controls of the skip control in FIG. 9C when the wobbling is generated.

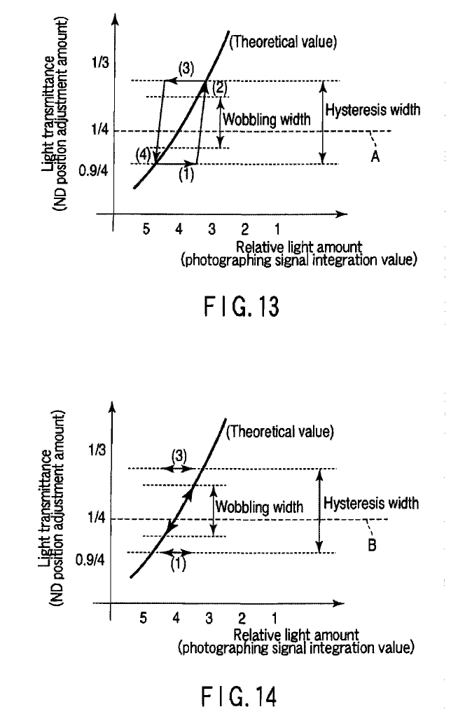

FIG. 13 is a diagram showing an example of the hysteresis width to be set in the ND filter control portion 54. FIG. 14 is a diagram showing a passage of a position adjustment amount of the ND filter group which is controlled based on the hysteresis width shown in FIG. 13.

In FIG. 13, this wobbling width is generated when the light transmittance (position adjustment amount of the ND filter group) is automatically controlled by the ND filter control portion 54 with respect to a relative light amount (integration value of the image pickup signal). FIG. 13 indicates that the ND filter control portion 54 sets up the hysteresis width with a width larger than the wobbling width containing a position (dotted line A) in which the transmittance change line and the diaphragm borderline approximately coincide with each other.

Unless any position in which the transmittance change line and the diaphragm borderline approximately coincide with each other exists, the light transmittance should be controlled based on the characteristic of a theoretical value shown in FIG. 13, because elimination of the transmittance change line by such substantial coincidence never occurs. However, if the position in which they approximately coincide exists, the skip control, which passes the position in which they approximately coincide, should be performed as described above.

However, even if this skip-control is carried out, if the wobbling width is generated as shown in FIG. 13, the skip-control is generated continuously. That is, the elimination and appearance of the transmittance change line are repeated continuously.

Even if the hysteresis width is set up as shown in FIG. 13 and the relation (theoretical value) between the relative light amount and the light transmittance surpasses the position in which the transmittance change line and the diaphragm borderline approximately coincide, it is necessary to control along a passage of hysteresis loop composed of arrow 1, arrow 2, arrow 3 and arrow 4 shown in FIG. 13 so as to suppress the position in which they approximately coincide with each other.

If the hysteresis width as shown in FIG. 13 is set up, even if the wobbling is generated, a closed amplitude control shown by arrow 1 or arrow 3 is implemented as shown in FIG. 14. At this time, the arrow 1 and arrow 3 show a passage which does not go over a position (dotted line B) in which the transmittance change line and the diaphragm borderline approximately coincide with each other.

Arrow 1 shows a passage which is generated in a process in which the ND position is adjusted from a light transmittance of 0.9/4 to a light transmittance of ⅓. Arrow 3 is a passage which is generated in a process in which the ND position is adjusted from a light transmittance of ⅓ to a light transmittance of 0.9/4.

In a control period for the passage on such a hysteresis loop, the ND filter control portion 54 makes a light transmittance (position of ND filter) different from the theoretical value shown in FIG. 13 and FIG. 14.

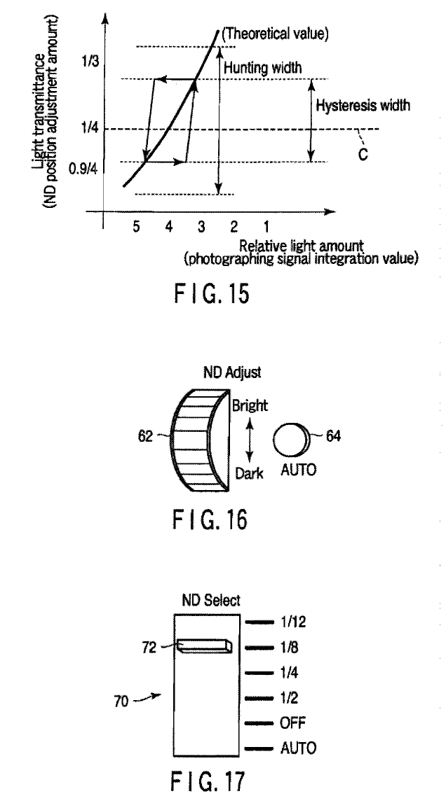

FIG. 15 is a diagram showing an example of a hunting width generated under the ND filter position adjustment amount (control amount).

As shown in FIG. 15, this hunting width refers to an ND filter position adjustment amount (control amount) having an amplitude larger than the hysteresis shown in FIG. 13. If a hunting width having an amplitude larger than the hysteresis width is generated as a control amount, the ND filter operation portion 56 is taken as priority by the control/operation priority mode selecting portion 58 shown in FIG. 12 after the positional relation of each ND filter is adjusted and stopped so as to prevent the transmittance change line and the diaphragm borderline from being stopped in an approximately coincident state.

By taking the ND filter operation portion 56 as priority and aborting control of the ND filter by the ND filter control portion 54, the hunting operation can be avoided.

FIG. 16 is an appearance diagram showing an example of the ND filter operation portion 56 disposed on an image pickup device casing surface and the control/operation priority mode selecting portion.

The ND filter operation portion 56 operates the ND filter adjusting portion 18, and, referring to FIG. 16, the ND adjust indicates the light transmittance from light to dark (light transmittance adjustment from light to dark) and its dial is provided.

The control/operation priority mode-selecting portion 58 selects which is taken into a priority mode, ND filter control portion 54 or the ND filter operation portion 56. For example, the AUTO (automatic) lit button is available as shown in FIG. 16. In the meantime, the ND filter operation dial 62 and the AUTO button 64 may be an integrated type dial/button which is selected by being rotated and can make a decision when it is pressed in.

For example, when the AUTO button 64 as shown in FIG. 16 is pressed an odd number of times, the control/operation priority mode selecting portion 58 may set the ND filter control portion 54 into the priority mode at the same time when the AUTO is lit, so that operation by the ND filter operation dial is ignored and the light transmittance of the ND filter group by the ND filter control portion is automatically adjusted.

When the AUTO button 64 as shown in FIG. 16 is pressed an even number of times, the control/operation priority mode selecting portion 58 may set the ND filter operation portion 56 into the priority mode at the same time when the AUTO goes off, so that the control signal of the ND filter control portion 54 is ignored and the control signal of the ND filter operation dial 62 or mechanical drive is taken as priority.

If this AUTO button 64 is pressed an even number of times, the wobbling operation of the ND filter group 16 is stopped immediately. Thus, this AUTO button 64 can be used not only for selection of the priority mode but also for stopping of the wobbling operation.

Because the ND filter operation dial 62 shown in FIG. 16 and the AUTO button 64 may be constructed according to another specification, this will be described for supplementation.

If the ND filter operation dial 62 is operated, the ND filter operation dial 62 may be automatically set to the priority mode in a period until the AUTO button 64 is pressed after that dial is operated.

According to this specification, if the AUTO button 64 is pressed, the ND filter control portion 54 may be automatically set to the priority mode in a period until the dial operation is performed.

FIG. 17 is an appearance diagram showing an example of the ND filter operation portion 56 and the control/operation priority mode selecting portion 58, disposed on the image pickup device casing surface.

Referring to FIG. 17, the ND filter operation portion 56 and the control/operation priority mode selecting portion 58 can be operated by means of a slide switch 70 having a protrusion 72 for setting so that the light transmittance is selectively changed to 1/12, ⅛, ¼, ½, OFF (light transmittance 1) or AUTO (automatic adjustment).

The ND filter operation portion 56 and the control/operation priority mode-selecting portion 58 may be constructed of an integrated member. Although this is a slide type switch as shown in the appearance diagram of FIG. 17, it can be a rotary switch, a dial which gives a sense of click when AUTO is selected, or a SLIDAC type switch. Further, it may be constructed as a remote control type.

As described above, the second embodiment concerns the image pickup device using the optical device of the first embodiment and describes an embodiment for automatic control of the ND filter group and/or manual operation of the ND filter group.

The second embodiment can provide an image pickup device including automatic/manual operations in optical design and optical control for reducing the small-aperture blurring of the optical image due to the optical diaphragm when the light amount of the optical image is adjusted.

Further, the second embodiment can provide an image pickup device including automatic control/manual operation in optical design and optical control for making the state of a moment when the ND filter is inserted when the ND filter is inserted into the aperture plane on photographing and recording.

Still further, the second embodiment can provide an image pickup device including automatic control/manual operation in such an optical design and optical control that the MTF in the horizontal direction and the MTF in the vertical direction of this optical image approximately coincide with each other or the deterioration ratios of at least the MTF deterioration in the horizontal direction and the MTF deterioration in the vertical direction are maintained approximately constant.

Still further, the second embodiment can provide an image pickup device including automatic control/manual operation in such an optical design and optical control that the change of the MTF deterioration due to the small-aperture blurring of the optical image is reduced even when the transmittance change line of the ND filter moves with respect to the aperture plane while changing.

Although the embodiments of the present invention have been described with reference to the drawings, the specific configuration is not limited to these embodiments but includes modifications of the design in a range not departing from the spirit of the present invention.

Further, the above-described embodiments include inventions of various stages, and various aspects of the invention can be extracted by appropriate combination of plural disclosed elements. For example, even if some elements are erased from all the elements shown in the embodiments, if the object to be solved by the invention can be solved and an effect which the invention intends to achieve can be achieved, a configuration from which some elements have been omitted can be also be extracted as the present invention.

According to the optical device of the present invention, there is an effect that the small-aperture blurring of the optical image due to the optical diaphragm is reduced when the light amount of the optical image is adjusted.

According to the present invention, there is an effect that even if the ND filter is inserted into the aperture plane on photographing and recording, the state of a moment when the ND filter is inserted is inconspicuous.

Further, according to the present invention, there is an effect that even if the transmittance change line of the ND filter exists within the aperture plane, the deterioration ratio between at least the MTF deterioration in the horizontal direction and the MTF deterioration in the vertical direction is maintained approximately constant.

According to the present invention, there is an effect that even when the transmittance change line moves with respect to the aperture plane while changing, the change of the MTF deterioration due to the small-aperture blurring of this optical image is reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An optical device, comprising:
an optical portion which generates an optical image on an image pickup area by focusing an image of a photographing object;
an optical diaphragm which narrows light flux optically when the optical portion generates the optical image;
an ND filter group which is disposed in front of or behind the optical diaphragm and constituted of a plurality of ND filters each having a different light transmittance; and
an ND filter adjusting portion which adjusts a positional relation of the each ND filter with respect to the optical axis of the optical portion,
wherein at least one of the plurality of ND filters is an oblique ND filter in which the transmittance change line which is a change line of the light transmittance intersects at least two sides constituting the image pickup area obliquely.

2. The optical device according the claim 1, wherein the ND filter adjusting portion adjusts the positional relation of each ND filter so as to prevent the transmittance change line and the diaphragm borderline which is a borderline between the blade of the optical diaphragm and the aperture plane of the optical diaphragm from being static in an approximately coincident state.

3. The optical device according to claim 2, wherein at least one of the ND filters is a parallelogram,
one of the diagonal directions of the parallelogram is approximately parallel to the horizontal direction of the image pickup area or the vertical direction of the image pickup area,
the optical diaphragm has a polygonal aperture plane having four or more corners, formed from a plurality of diaphragm blades, and
the transmittance change line is approximately parallel to two sides of the polygonal shape.

4. The optical device according to claim 2, wherein the optical diaphragm is formed from two diaphragm blades, and
the polygonal aperture plane is convertible to a square aperture plane or hexagonal aperture plane.

5. The optical device according to claim 4, further comprising an ND filter control portion which controls the ND filter adjusting portion,
wherein when the polygonal aperture plane forms the square aperture plane, the ND filter control portion controls the ND filter adjusting portion so that the transmittance change line exists within the square aperture plane.

6. The optical device according to claim 4, further comprising an ND filter control portion which controls the ND filter adjusting portion,
wherein when the polygonal aperture plane forms the hexagonal aperture plane, the ND filter control portion controls the ND filter adjusting portion so that the transmittance change line does not exist within the hexagonal aperture plane.

7. An image pickup device using the optical device according to claim 1, further comprising an image pickup portion which is disposed on the image pickup area so as to convert the optical image photoelectrically to generate an image pickup signal.

8. The image pickup device using the optical device according to claim 2, further comprising:
an image pickup portion which is disposed on the image pickup area so as to convert the optical image photoelectrically to generate an image pickup signal; and
an ND filter control portion which controls the ND filter adjusting portion based on an integration value of the image pickup signal,
wherein the ND filter control portion controls a wobbling width including a position in which the transmittance change line and the diaphragm borderline approximately coincide with each other based on a hysteresis larger than the wobbling width so that the position of the ND filter group is not wobbled.

9. The image pickup device using the optical device according to claim 3, further comprising:
an image pickup portion which is disposed on the image pickup area so as to convert the optical image photoelectrically to generate an image pickup signal; and
an ND filter control portion which controls the ND filter adjusting portion based on an integration value of the image pickup signal,
wherein the ND filter control portion controls a wobbling width including a position in which the transmittance change line and the diaphragm borderline approximately coincide with each other based on a hysteresis larger than the wobbling width so that the position of the ND filter group is not wobbled.

10. The image pickup device according to claim 8, further comprising:
an ND filter operating portion which operates the ND filter adjusting portion; and
a control/operation priority selecting portion which selects which of the ND filter control portion and the ND filter operating portion is given priority,
wherein when the ND filter operating portion is operated, the ND filter operating portion is automatically selected with priority in a period until the ND filter control portion is selected with priority by the control/operation priority selecting portion after the ND filter operating portion is operated.

11. The image pickup device according to claim 9, further comprising:
an ND filter operating portion which operates the ND filter adjusting portion; and
a control/operation priority selecting portion which selects which of the ND filter control portion and the ND filter operating portion is given priority,
wherein when the ND filter operating portion is operated, the ND filter operating portion is automatically selected with priority in a period until the ND filter control portion is selected with priority by the control/operation priority selecting portion after the ND filter operating portion is operated.

12. The image pickup device according to claim 10, wherein the ND filter operating portion and the control/operation priority selecting portion are constructed of an integrated member, and
the ND filter adjusting portion is operated by the ND filter operating portion so that plural light transmittances are selectively changed over.

13. The image pickup device according to claim 10, wherein the ND filter operating portion and the control/operation priority selecting portion are constructed of an integrated member, and
the ND filter adjusting portion is operated by the ND filter operating portion so that plural light transmittances are selectively changed over.

14. The image pickup device according to claim 8, further comprising:
an ND filter operating portion which operates the ND filter adjusting portion; and
a control/operation priority selecting portion which selects which of the ND filter control portion and the ND filter operating portion is given priority,
wherein if a hunting width having an amplitude larger than the hysteresis width is generated as a control amount, the ND filter operation portion is automatically selected with priority by the control/operation priority selecting portion, after the positional relation of each ND filter is adjusted and stopped so as to prevent the transmittance change line and the diaphragm borderline from being stopped in an approximately coincident state.

15. The image pickup device according to claim 9, further comprising:
an ND filter operating portion which operates the ND filter adjusting portion; and
a control/operation priority selecting portion which selects which of the ND filter control portion and the ND filter operating portion is given priority,
wherein if a hunting width having an amplitude larger than the hysteresis width is generated as a control amount, the ND filter operation portion is automatically selected with priority by the control/operation priority selecting portion, after the positional relation of each ND filter is adjusted and stopped so as to prevent the transmittance change line and the diaphragm borderline from being stopped in an approximately coincident state.

16. An image pickup device using the optical device according to claim 2, further comprising an image pickup portion which is disposed on the image pickup area so as to convert the optical image photoelectrically to generate an image pickup signal.
